(19) United States
(12) Patent Application Publication
(10) Pub. No.: US 2024/0401724 A1
(43) Pub. Date: Dec. 5, 2024

(54) COILED GARDEN HOSE

(71) Applicant: Yeiser Research & Development LLC, Santee, CA (US)

(72) Inventor: John O. Yeiser, IV, Santee, CA (US)

(21) Appl. No.: 18/679,228

(22) Filed: May 30, 2024

Related U.S. Application Data
(60) Provisional application No. 63/469,740, filed on May 30, 2023.

(51) Int. Cl. F16L 11/12; F16L 11/08; F16L 11/16

(52) U.S. Cl. CPC F16L 11/12; F16L 11/08; F16L 11/16

(57) ABSTRACT

A coiled hose assembly includes a flexible outer shell formed over a flexible, water-tight inner tubing with hose fittings at both ends, where the assembly is wound around a cylindrical form and heated to anneal the assembly into a coiled configuration.

### RELATED APPLICATIONS

This application claims the benefit of the priority of U.S. Provisional Application No. 63/469,740, filed May 30, 2023, which is incorporated herein by reference in its entirety.

### FIELD OF THE INVENTION

The present invention relates to a water hose and more particularly to a coiled garden hose assembly.

### BACKGROUND OF THE INVENTION

Homeowners, gardeners, maintenance workers, and others who require water to maintain or clean outdoor areas are constantly looking for ways to manage and simplify their access to water sources. Conventional garden hoses made of rubber or heavy rubber-like materials reinforced with embedded webbing or fabric strands tend to be difficult to handle—they can be heavy and fairly stiff, resisting uncoiling, especially when cool, causing them to be dragged across, and causing damage to, nearby plants or landscape features when the user tries to stretch the hose to reach a remote location. When lighter weight plastics are used to manufacture such hoses, they tend to kink and/or puncture easily.

One relatively recent approach to the drawbacks of conventional rubber hoses has been the flat hose, for example, those sold under the trademarks XHOSE® and POCKET HOSE® (see, e.g., U.S. Design Pat. No. 731,032), which combines a thin, flexible, highly expandable PVC (polyvinylchloride) tubing surrounded by a NYLON® or other fabric sleeve, with conventional hose fittings on the ends. Such hoses are lightweight and easy to manage, but possess a number of disadvantages, including catastrophic failures that can occur at stress points along the hose, causing the hose to form a bubble at a weak point and abruptly burst. Also, they are easily punctured by cactus spines, sticks, and sharp edges that may be encountered while working in a garden or construction site and are subject to damage by pets or other animals chewing on the hose. Finally, because pressure is necessary to expand the hose to allow water to flow, the flat hoses are ineffective for applications such as transferring water from rain barrels or other non-pressurized water sources.

Coil hoses have been in the industry for many years formed of a polyvinylchloride (PVC), polyurethane (PU) or similar extruded tube in which the extrusion forms the shape of a coil. This hose provides a benefit to the user in that when you stretch it out to full length the hose will contract, like a spring, back to its resting, coiled configuration, thus eliminating the need for the user to wind the hose back up for storage.

A type of hose that is often used in industrial settings has a braided or coiled metal outer hose encasing a flexible inner rubber or PVC hose. Metal-shelled hoses possess several desirable features including resistance to burst, crush, puncture, and abrasion. Such hoses are comparable in weight to conventional rubber hoses, or even lighter, but are easier to flex for positioning, provided that the degree of curvature is large enough that they are not forced to bend at a sharp angle. The bending limitation tends not to be a problem in industrial applications, where hoses are used to attach a stationary machine to a water source and are not subject to frequent re-positioning, however, it can become a significant problem for use in the garden or around the home, where stretching and pulling on the hose around corners are commonplace. Since the usual manner of reaching a remote location with a garden hose is to keep pulling until it stops, a considerable amount of stress and strain can be applied to fitting at the faucet end of the hose. While a rubber or flat hose may be able to hold up to being pulled at a relatively sharp angle near the faucet end, the outer shell of a metal hose is susceptible to kinks and breakage if pulled too forcefully at an angle that is less that the natural curvature of the metal shell, permanently crimping or distorting the protective metal coils and exposing the inner tubing to damage. Thus, while many of the features of a hose with an outer metal shell would be desirable for garden hose applications, existing metal-shelled hoses are not constructed to tolerate the abuse to which everyday garden hoses are frequently subjected. Furthermore, metal-shelled hoses need to be rewound after use, which can be cumbersome and time consuming.

The need remains for a hose design that provides the advantages of a metal-shell construction in conjunction with an automatic rewinding feature.

### BRIEF SUMMARY

The inventive hose incorporates a flexible strip wound metal cover which extends the entire length of the hose. The metal casing provides many benefits to the current version including puncture resistance, abrasion resistance, UV resistance, all while being lightweight and easily manageable. The flexible metal cover is formed from a flexible, low friction material, where the metal strip wound cover is significantly more flexible than the inner PVC coil extrusion. If the outer cover were to present significant resistance, it could counter the stored spring energy of the inner coil extrusion when the hose is extended by the user. The outer casing must have very low resistance so as not to overcome the energy stored in the extended PVC coil that causes the hose to easily retract into its original coiled, compact size once the countering force of the user's pull on the hose is released.

The inventive hose is assembled by wrapping an inner hose formed from PVC, PU, PTFE, or similar material, with metal, fabric, polymer, or other suitable material. In the embodiment described herein, the outer wrapping is a helical coil of 304 stainless steel. Other materials that may be used include other metals, including aluminum, galvanized or other steel, titanium, rubber, durable (impact resistant) plastic or polymer, KEVLAR®, or other durable material, which may be braided, woven, coiled or otherwise formed to enhance durability and flexibility of the assembly.

The wrapped hose is wound around a cylindrical form as is commonly used in the manufacture of standard NYLON™ or PVC coiled hoses. The assembly is then heated so that both the metal and inner hose anneal into the shape of the form. The forming process can alternatively be done with forming tools, molds, stitching (fabric or woven), or other methods.

In some embodiments, the metal-shelled hose assembly may be integrated with a bendable strain-relief section configured to allow the metal-shelled hose to be pulled from a straight angle regardless of where it is attached. Such a structure is disclosed in U.S. Pat. Nos. 10,267,437 and 10,995,886, which are incorporated herein by reference.

### BRIEF DESCRIPTION OF THE DRAWINGS

FIGS. 1A and 1B are diagrammatic side views of the coiled hose according to an embodiment of the invention, where FIG. 1A shows the hose in the contracted configuration and FIG. 1B shows the hose in a stretched configuration.

FIG. 2 is partial cross-section view of an assembly of an inner hose tube with a metal-shell.

FIGS. 3A and 3B are top and side views, respectively, of the hose assembly of FIG. 2 wrapped around a cylindrical form.

FIG. 4 is a diagrammatic view of a coiled hose with the protective boot removed to reveal the strain relief section near the female end fitting.

### DETAILED DESCRIPTION OF EMBODIMENTS

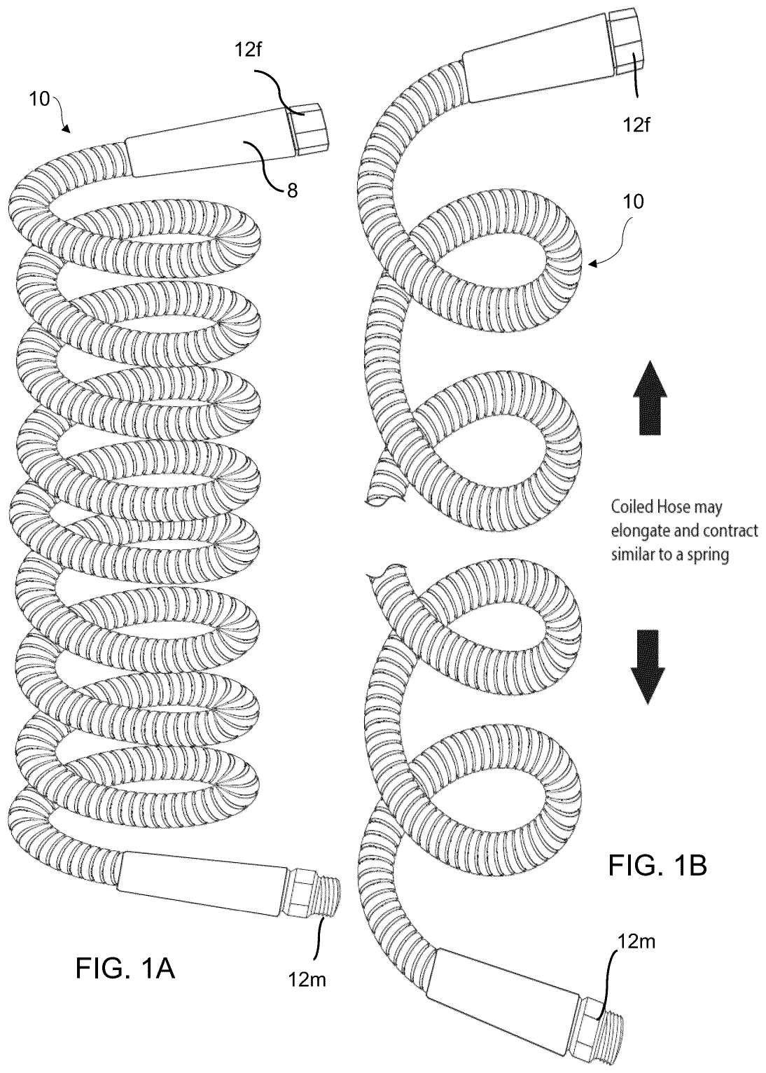

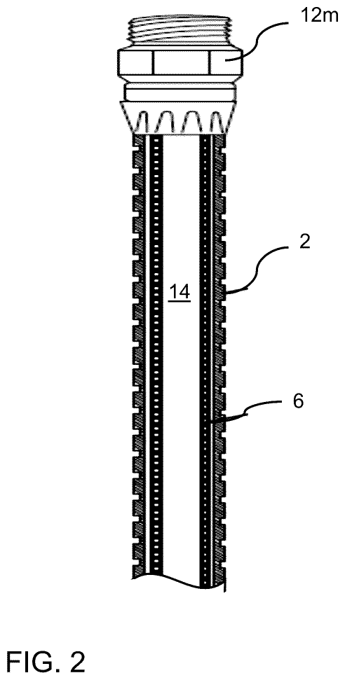

FIGS. 1A-4 illustrate the components of an embodiment of the inventive coiled hose assembly 10. The hose incorporates a lightweight durable outer cover 2 that extends the entire length of the hose (from end fitting 12f (female end) to end fitting 12m (male end)). The ends of the hose closest to the fittings may be covered with an optional protective boot 8 which provides a hand grip and increases user comfort. The cover 2 is formed from a material that provides the assembly with puncture resistance, abrasion resistance, and UV resistance, all while being lightweight and easy to manipulate. In some embodiments, the cover is formed from a long metal strip formed from a flexible, low friction material, which is coiled around the inner hose 6. The metal strip wound cover (or other cover material) is configured to be significantly more flexible than the inner hose 6. If the outer cover were to be less flexible than the inner hose 6, it might counteract the stored spring energy of the inner coil extrusion when the hose is extended by the user. The outer casing 2 must have very low resistance so as not to overcome the energy stored in the extended coil hose 6 that causes the hose to easily retract into its original coiled, compact size once the countering force of the user's pull on the hose is released.

The inventive hose is assembled by wrapping an inner hose 6 formed from a thermoplastic polymer such as polyvinyl chloride (PVC), polyurethane (PU), polytetrafluoroethylene (PTFE), polyamide (PA) (including NYLON™), or similar material, with metal, fabric, polymer, or other suitable protective material. The material of which hose 6 is formed should be sufficiently rigid to maintain its cross-sectional shape to create an open flow path 14 even when no water pressure is applied. The relative flexibility of the outer cover 2 is that the cover material must be more flexible that the inner hose material to ensure that the spring characteristic of the hose material key is not countered by the cover so that the assembly will resile to a coiled configuration when pulling force is released. In the embodiment described herein, the outer wrapping is a helical coil 2 of 304 stainless steel. Other materials that may be used include other metals, including aluminum, galvanized or other steel, titanium, rubber, durable (impact resistant) plastic or polymer, KEVLAR®, or other durable material, which may be braided, woven, coiled or otherwise formed to enhance durability and flexibility of the assembly.

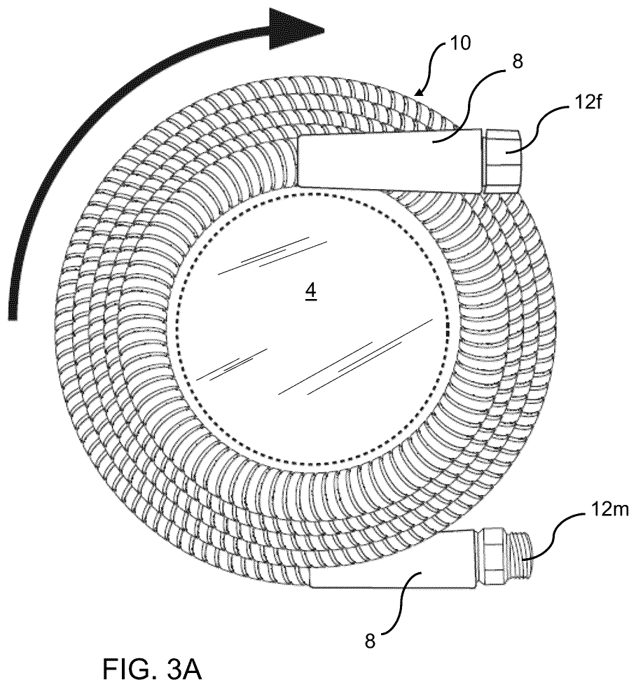

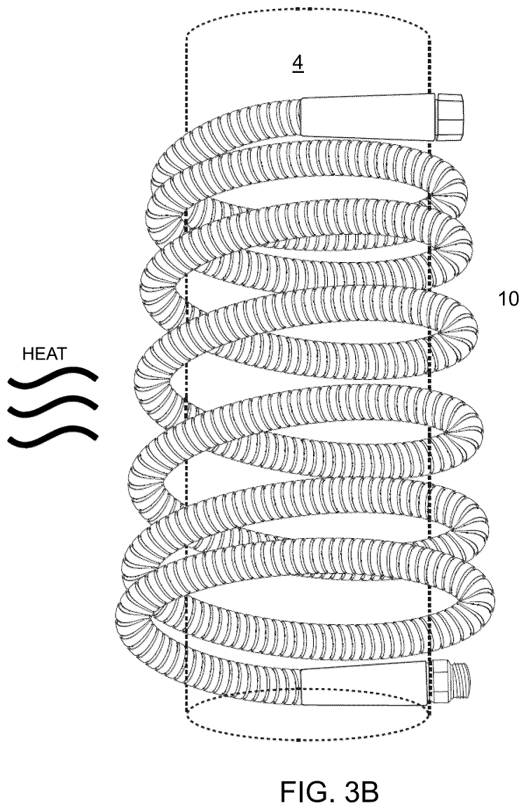

In known methods for producing a coiled tubing from a thermoplastically-processable polymer, an extruded tube with a predetermined cross-section is cut to length, wound helically around a mandrel in a cold state, preferably at room temperature, so that the longitudinal axis of the tube is at approximate right angles to the mandrel (see, e.g., FIG. 3B), and subsequently subjected to heat. Such methods for the production of coiled tubing by subsequent shaping by winding and applying heat of a sufficient temperature to soften and/or anneal the tubing to cause the tubing to adopt the shape of the mandrel. In some methods, a heated liquid may be flowed through the tubing. In other approaches, the mandrel can be heated by internal heating elements, the wrapped mandrel and hose can be placed in an annealing oven or a heated bath, or other methods may be used to heat the tubing to a temperature below the melting point of the material, so that it softens but does not melt. After heating, the tubing and mandrel are cool to cause the tubing to retain its coiled form. Sample processes used for forming coil hoses are described in U.S. Pat. Nos. 3,021,871and 3,245,431, and European Patent Application EP1270173 A1, each of which is incorporated herein by reference.

To manufacture the inventive coiled hose assembly, the wrapped hose assembly 10, with the end fittings 12f, 12m attached, is wound around a cylindrical mandrel 4 as described above. The winding may be done manually or may be automatically applied to a rotating mandrel by machinery configured to feed the hose assembly onto the mandrel. The wrapped hose assembly and mandrel 4 are then heated by appropriate means so that both the metal and inner hose anneal into a helical shape. As described above, heating (annealing) may be achieved by including a heating element located within the mandrel 4, by placing the hose assembly and the mandrel into an oven, flowing a heated fluid through the tubing after winding around the mandrel, or a combination thereof. The temperature required for permanently deforming the tubing into a coiled configuration will depend on the specific material used. Considerations in selecting the temperature include ensuring that other materials in the hose assembly are not melted or damaged by the heat. The forming process can alternatively be done with forming tools, molds, stitching (fabric or woven), or other methods, as long as the relative flexibilities of the inner tubing 6 and the outer cover are maintained. After heating, the assembly is cooled to room temperature causing the hose assembly to retain its helical form, acting as a resilient spring that can be easily extended by pulling an end of the hose with enough force to overcome the spring's resistance. Upon release of the pulling force, the spring force of the inner hose will cause the assembly to resile to its compact, coiled condition.

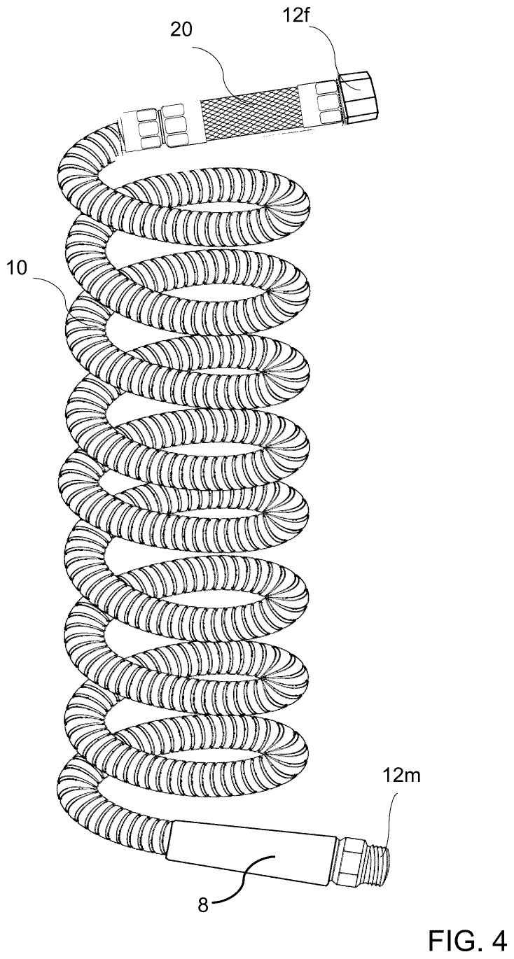

In some embodiments, the hose assembly 10 may be integrated with a bendable strain-relief section configured to allow the hose assembly to be pulled from a straight angle regardless of where it is attached. The details and assembly of such a structure are disclosed in U.S. Pat. No. 10,267,437, which is incorporated herein by reference in its entirety. FIG. 4 is a diagrammatic view of the coiled hose assembly where the upper protective boot 8 is removed to reveal the strain relief section 20.

The coiled hose described herein provides a lightweight alternative to conventional rubber hoses, with improved flexibility and durability. The protective metal shell makes the hose puncture proof, thorn proof, tear proof, weatherproof, kink proof, and animal proof while the coiled configuration allows the hose to automatically resile into a compact, easily stored configuration after use. Because the hose maintains its open inner structure even when water is not flowing under pressure, it avoids the drawbacks of flat garden hoses that require pressure to expand the flow path.

While the invention has been described with reference to a preferred embodiment, it should be understood that modifications and variations are possible without departure from the scope and spirit of the invention, which is intended to be limited only by the appended claims.

1. A hose assembly comprising:
a flexible outer shell having a proximal end, a distal end and a first flexibility;
a resilient inner hose having a proximal end, a distal end and a second flexibility, wherein the second flexibility is less than the first flexibility, the inner hose configured to be disposed coaxially within the outer shell wherein the second flexibility controls a combined flexibility of the inner hose and outer shell;
an inlet fitting connected to the proximal end of each of the outer shell and the inner hose, the inlet fitting configured for releasable connection to a water source; and
an outlet fitting connected to the distal end of each of the outer shell and the inner hose;
wherein the hose assembly is configured to define a resilient spring wherein the resilient spring is configured to be expandable when an extending force is applied near the outlet fitting and to resile to a coiled configuration when the extending force is released.

2. The hose assembly of claim 1, further comprising at least one strain relief assembly disposed at least between the inlet fitting and the proximal ends of the outer shell and the inner hose.

3. The hose assembly of claim 1, wherein the outer shell is a coiled metal.

4. The hose assembly of claim 3, wherein the coiled metal is stainless steel.

5. The hose assembly of claim 1, further comprising a protective boot disposed over the distal and proximal ends of the outer shell.

6. The hose assembly of claim 1, wherein the inner hose is formed from a thermoplastic polymer.

7. The hose assembly of claim 6, wherein the thermoplastic polymer is one or more of polyvinyl chloride (PVC), polyurethane (PU), polytetrafluoroethylene (PTFE), and polyamide (PA).

8. The hose assembly of claim 1, wherein the resilient spring is defined by:
winding the hose assembly on a cylindrical mandrel;
exposing the hose assembly to thermal annealing to a temperature configured to soften and deform the inner hose to the coiled configuration; and
cooling the hose assembly to retain the coiled configuration.

9. A method for making a flexible coiled hose, comprising:
winding the hose assembly of claim 1 on a cylindrical mandrel;
exposing the hose assembly to thermal annealing to a temperature configured to soften and deform the inner hose to the coiled configuration; and
cooling the hose assembly to retain the coiled configuration.

10. A hose assembly comprising:
a resilient inner hose having a proximal end, a distal end and a first flexibility;
a flexible outer shell having a proximal end, a distal end and a second flexibility, wherein the second flexibility is greater than the first flexibility, wherein the inner hose is configured to be disposed coaxially within the outer shell and wherein the second flexibility controls a combined flexibility of the inner hose and outer shell;
an inlet fitting connected to the proximal end of each of the outer shell and the inner hose, the inlet fitting configured for releasable connection to a water source; and
an outlet fitting connected to the distal end of each of the outer shell and the inner hose;
wherein the hose assembly is configured as a resilient spring configured to be expandable when an extending force is applied near the outlet fitting and to resile to a coiled configuration when the extending force is released.

11. The hose assembly of claim 10, further comprising at least one strain relief assembly disposed at least between the inlet fitting and the proximal ends of the outer shell and the inner hose.

12. The hose assembly of claim 10, wherein the outer shell is a coiled metal.

13. The hose assembly of claim 12, wherein the coiled metal is stainless steel.

14. The hose assembly of claim 10, further comprising a protective boot disposed over the distal and proximal ends of the outer shell.

15. The hose assembly of claim 10, wherein the inner hose is formed from a thermoplastic polymer.

16. The hose assembly of claim 15, wherein the thermoplastic polymer is one or more of polyvinyl chloride (PVC), polyurethane (PU), polytetrafluoroethylene (PTFE), and polyamide (PA).

17. The hose assembly of claim 10, wherein the resilient spring is defined by:
winding the hose assembly on a cylindrical mandrel;
exposing the hose assembly to thermal annealing to a temperature configured to soften and deform the inner hose to the coiled configuration; and
cooling the hose assembly to retain the coiled configuration.

18. A method for making a flexible coiled hose, comprising:
winding the hose assembly of claim 10 on a cylindrical mandrel;
exposing the hose assembly to thermal annealing to a temperature configured to soften and deform the inner hose to the coiled configuration; and
cooling the hose assembly to retain the coiled configuration.
